(19) United States
(12) Patent Application Publication
(10) Pub. No.: US 2023/0274233 A1
(43) Pub. Date: Aug. 31, 2023

(54) MACHINE LEARNING-BASED RECRUITMENT SYSTEM AND METHOD

(71) Applicant: Hariharan Sivaraman, San Carlos, CA (US)

(72) Inventor: Hariharan Sivaraman, San Carlos, CA (US)

(21) Appl. No.: 17/682,553

(22) Filed: Feb. 28, 2022

Related U.S. Application Data
(60) Provisional application No. 63/198,067, filed on Dec. 30, 2020.

(51) Int. Cl. G06Q 10/10

(52) U.S. Cl. CPC G06Q 10/1053

(57) ABSTRACT

A system and method to aid in a recruitment process by providing a list of candidates that best match the job requirement. The system includes an explainable machine learning module that applies six layers of filters and profile matching to a set of job applications to shortlist a predefined number of applications. The shortlisted applications can be presented to recruited for logical assessment about the relevancy of each of the shortlisted applications. Based on the self-assessment, the set of applications can again be processed by the explainable machine learning module to shortlist a final list of candidates.

### CROSS-REFERENCE TO RELATED APPLICATIONS

This application claims priority to the U.S. provisional Pat. application Ser. No. 63/198,067 filed on Dec. 30, 2020, which is incorporated herein by reference in its entirety.

### FIELD OF INVENTION

The present invention relates to the machine learning-based system and method for recruitment, and more particularly, the present invention relates to an explainable machine learning model for recruitment.

### BACKGROUND

The term recruitment broadly refers to the process of hiring candidates for job positions in organizations. Recruitment is an important process in every organization through which new employees are hired. Recruitment, however, is a multiple-step complex process. The first step in the process is to figure out the requirements for a vacant job and generate an advertisement based on the requirements. Then reaching out to invite applications from candidates by publishing the advertisement. The advertisement can be published through a variety of sources, such as printing in newspapers or magazines, online job portals, and the like. The received applications are then analyzed to shortlist candidates for further processing, such as an interview.

Often an overwhelming number of applications can be received by an organization for one or a few job positions, specifically by big organizations. To analyze such a large number of applications requires manpower and a lot of working hours. This escalates the cost of recruitment and makes the process tedious. Additionally, the human factor makes the process less efficient because of the bias introduced into the recruitment process.

Various kinds of software are available that makes the process of reviewing the applications faster. Most of such software is organizing and collaborating software that only automates a few steps in the analysis.

Thus, a need is appreciated for a system and method that can shortlist candidates from a bulk of applications and avoid human bias in the analysis process.

Hereinafter, the terms “profile(s)”, “application(s)”, and “job application(s)” are interchangeably used and refers to a disclosure from a candidate showing an interest in a job position, and the disclosure includes details of the candidates such as the personal details, contact details, work experience, education, and the like relevant for a recruitment process.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method that can automate shortlisting of candidates from a bulk of job applications.

It is another object of the present invention that a human bias in the selection process can be minimized.

It is still another object of the present invention that the system can actively learn the job requirements.

It is yet another object of the present invention that the system uses machine learning models to analyze the applications.

It is a further object of the present invention that the machine learning model is explainable.

In one aspect, dislcosed is a system to aid in a recruitment process, the system comprising a processor and a memory, the system configured to implement a method comprising the steps of receiving a set of applications for one or more job vacancies; subjecting the set of applications to a machine learning based multi-layered analysis module, wherein the analysis module upon execution by the processor applies a plurality of filters to the set of applications and further subject the set of applications to profile matching, wherein the analysis module is explainable; scoring, by the analysis module, each application of the set of applications; presenting, by the analysis module, a predetermined number of applications from the set of applications based on the scoring; receive a logical assessment for each of the predetermined number of applications; updating, the analysis module using reinforcement learning and the logical assessment of the each of the predetermined number of applications; and upon updating, determining a list of shortlisted applications from the set of applications by subjecting the set of applications to the updated analysis module. The plurality of filters comprises six layers of filtering. The updated analysis module causes rescoring of the each of the set of applications. The method further comprises the steps of receiving a self-assessment form from a plurality of candidates of the set of applications. The method further comprises the steps of receiving a benchmark application, wherein the benchmark application and the self-assessment form are used for the profile matching. The predetermined number of applications are presented such that certain predefined information in the predetermined number of applications is masked to prevent human bias in the logical assessment. The method further comprises the steps of providing an interface to receive a weightage for a plurality of hard and soft skill requirements for the one or more job vacancies.

In one aspect, disclosed is a method to aid in a recruitment process, the method implemented within a system comprising a processor and a memory, the method comprising the steps of receiving a set of applications for one or more job vacancies; subjecting the set of applications to a machine learning based multi-layered analysis module, wherein the analysis module upon execution by the processor applies a plurality of filters to the set of applications and further subject the set of applications to profile matching, wherein the analysis module is explainable; scoring, by the analysis module, each application of the set of applications; presenting, by the analysis module, a predetermined number of applications from the set of applications based on the scoring; receive a logical assessment for each of the predetermined number of applications; updating, the analysis module using reinforcement learning and the logical assessment of the each of the predetermined number of applications; and upon updating, determining a list of shortlisted applications from the set of applications by subjecting the set of applications to the updated analysis module.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram illustrating an architecture of the system, according to an exemplary embodiment of the present invention.

FIG. 2 is a flowchart illustrating the disclosed methodology for the machine learning-based shortlisting of candidates from the bulk of applications for a job position, according to an exemplary embodiment of the present invention.

FIG. 3 shows an implementation of the interface, which is a screen showing score, according to an exemplary embodiment of the present invention.

FIG. 4 shows another implementation of the interface, which is a screen for diversity and inclusion features, according to an exemplary embodiment of the present invention.

FIG. 5 shows another implementation of the interface, which is a screen to capture profiles that can be used to analyze applications, according to an exemplary embodiment of the present invention.

FIG. 6 shows another implementation of the interface, which is a screen to capture job requirements, according to an exemplary embodiment of the present invention.

FIG. 7 shows another implementation of the interface, which is a screen illustrating the self-assessment form, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a system and method for aiding the organizations to get a list of shortlisted profiles or applications for different job positions/vacancies. Disclosed is a machine learning-based system that analyzes the bulk of job applications to get a list of a predetermined number of shortlisted applications that can be processed further, such as scheduling interviews. Disclosed is a reinforcement learning-based machine learning model that is explainable and can learn job requirements to find out best matches from the available pool of job applications. The disclosed system and method can significantly reduce human bias in the recruitment process. Moreover, the time-consuming step of manually reviewing the bulk of applications can be done in a noticeably brief time with more accuracy, and this enhances both productivity and efficiency. Different organizations can use the disclosed system and method to quickly get a list of candidates that best matches their job requirements. For example, ten scrutinized applications can be provided to the human resource team of an organization. The advantage of the disclosed system is an explainable machine learning model that can help the HR team to understand the analysis done by the machine learning model and thus be more confident about the shortlisted applications.

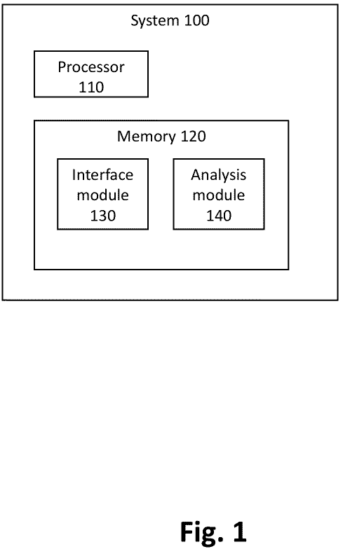

Referring to FIG. 1 which is a block diagram showing an architecture of the disclosed system. The disclosed system and method implemented within the system can analyze a bulk of job applications to get a predetermined number of applications that best match the job requirements. The disclosed system 100 can include a processor 110 and a memory 120. The memory can include an interface module 130 and an analysis module 140. The modules can be software, program, code, or a set of instructions that upon executing by the processor perform the disclosed methodology of shortlisting the job applications. The interface module 130 upon execution by the processor can provide an interface that allows users to interact with the disclosed system to both upload and download information. The interface can be implemented as multiple screens, each screen for a specific function, such as receiving job requirements, receiving self-assessment from candidates, and like aspects of the invention discussed below. The analysis module can analyze a bulk of applications using a machine learning model implemented within the system, to shortlist a predefined number of applications that best match the job requirements.

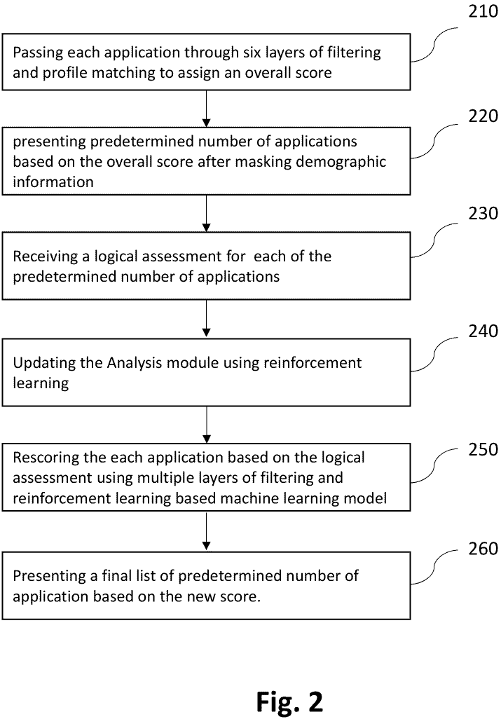

Referring to FIG. 2 which is a flowchart illustrating a disclosed methodology of shortlisting candidates for a job application. A bulk of applications from a variety of sources can be analyzed by the disclosed analysis module that is based on machine learning. Each application can pass through six layers of filtering and profile matching, at step 210. The analysis module through an interface generated by the interface module can receive job requirements. The analysis module then based on the job requirements can analyze the bulk of applications using machine learning-based filtering and profile matching. Each application can be assigned a score by the analysis module. The disclosed analysis module can be explainable, i.e., the steps behind scoring can be explainable so that the recruiters can be more confident with the shortlisted candidates.

The disclosed analysis module can then present the shortlisted applications that have the highest score, at step 220. The number of applications to be presented can be discretionary, for example, the recruiter may want ten shortlisted applications. The shortlisted applications can be presented to the recruiter or the user through the interface for assessment. The disclosed analysis module can mask certain fields in the shortlisted applications to prevent any bias in the assessment of the shortlisted applications by the user. The fields to be masked can also be predefined and can include religion, color, gender, and the like. The user can review each of the shortlisted applications to provide an assessment for each shortlisted application, at step 230. The assessment can be whether the shortlisted application is relevant or not relevant to the user. The assessment can be logical wherein the user can say yes or no to a shortlisted application. For example, to each application, two icons i.e., thumbs up and thumbs down can be provided by the interface, wherein the user can select any of the two icons. If the shortlisted application is relevant to the user, the user can mark the thumbs up icon for the application i.e., the logical yes. If the application is not relevant to the user, the user can mark the thumbs down icon, i.e., the logical assessment as no.

The disclosed analysis module can input the logical assessment received for each shortlisted application from the user and can redefine the profile matching criteria using the reinforcement learning approach, at step 240.

The bulk of applications or a set of the bulk of applications can then be re-scored by subjecting the applications to filtering and profile matching step by the updated analysis module, at step 250. The above process can be repeated until the desired set of shortlisted applications can be received by the user. The final set of shortlisted applications can then be presented to the user for further processing such as scheduling interviews, at step 260.

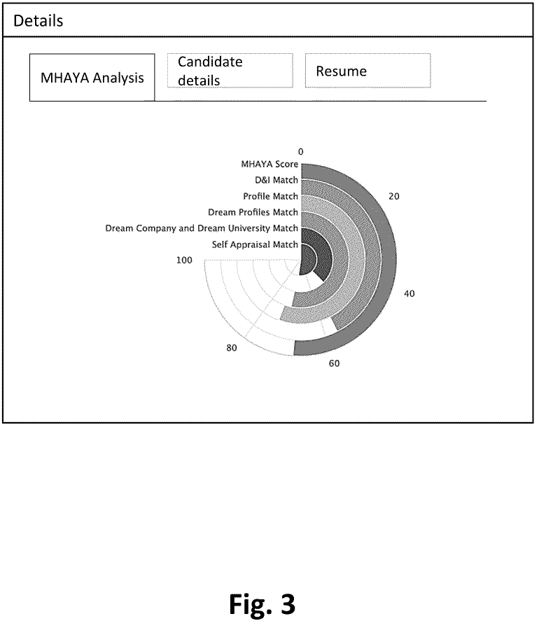

Referring to FIG. 3 which illustrates an interface, and more specifically a screen of the interface showing scoring of each job application based on several parameters or filters. The disclosed analysis module combines multiple artificial intelligence features ranging from heuristics, conventional machine learning, and reinforcement learning resulting in a powerful, accurate, explainable and ethical system to help organizations with their recruiting needs.

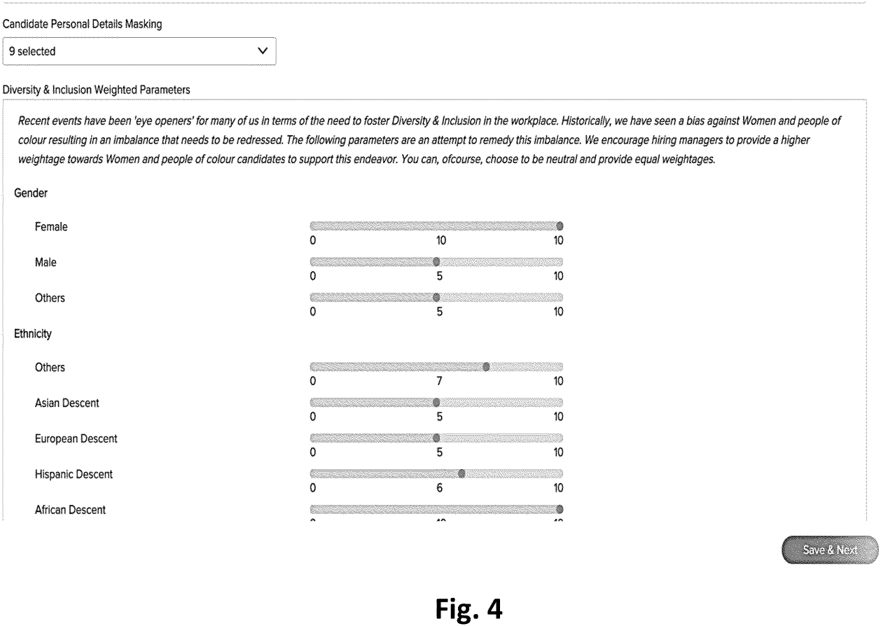

Referring to FIG. 4 which shows another screen generated by the interface module for receiving criteria for masking certain information in the shortlisted profiles that are presented to the recruiter. The disclosed feature can significantly reduce bias in the recruitment by masking certain information in the profiles presented for assessment by the users. The information masked can be related to gender, ethnicity, name, location, etc. however, the disclosed system can also handle intentional bias that may be introduced for certain objects, such as to redress imbalances in organization composition. The screen in FIG. 4 shows options to assign weightage to different parameters, such as gender and ethnicity. The system can receive input through the screen shown in FIG. 4, wherein the input can become a part of the job requirement and be used as a factor in profile filtering and matching.

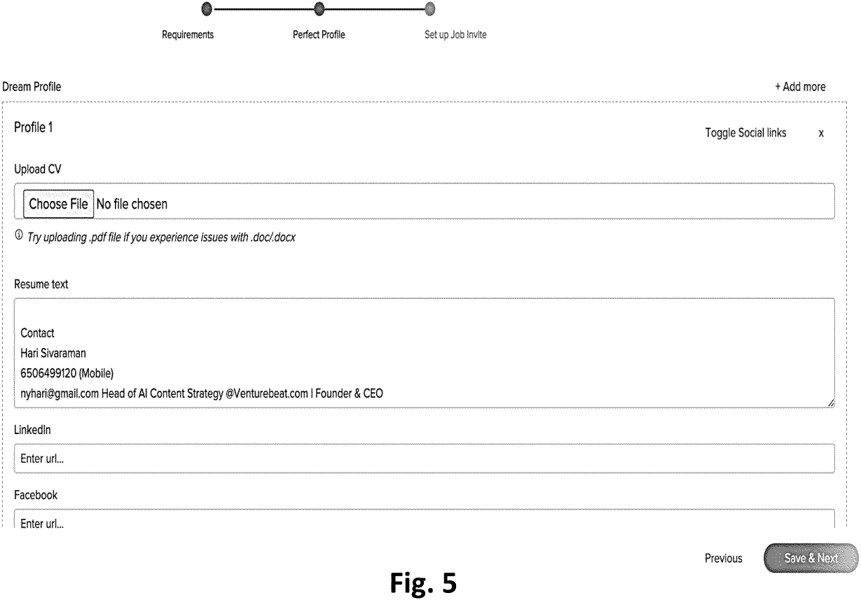

Referring to FIG. 5 which shows another interface that allows the users to provide a benchmark application that can be used in the analysis. Referring to FIG. 3, dream profile match and dream company and dream university match can be obtained through the screen shown in FIG. 5.

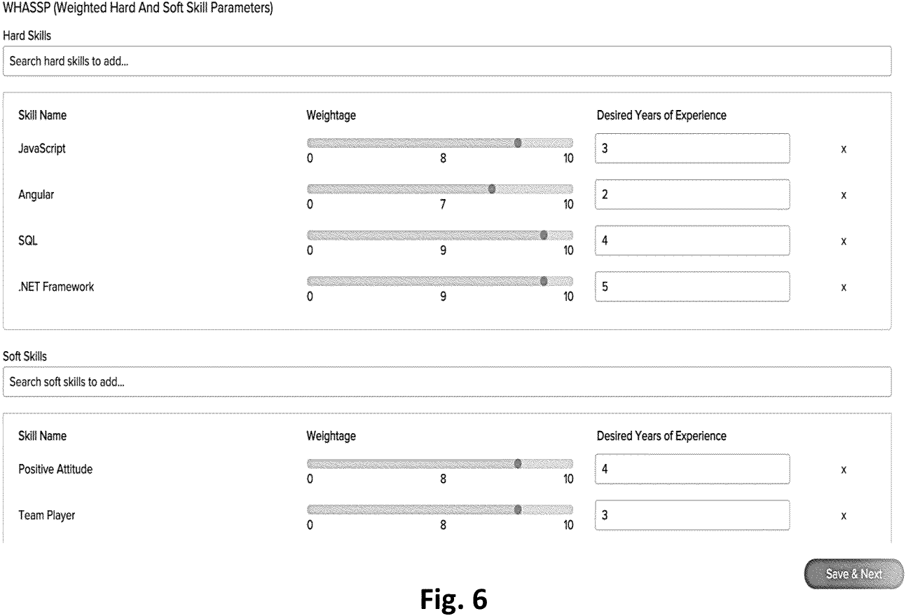

Referring to FIG. 6 which shows another screen to take added input from the user for the job requirements. The user can specify the weightage of different hard and soft skills parameters through the screen shown in FIG. 6.

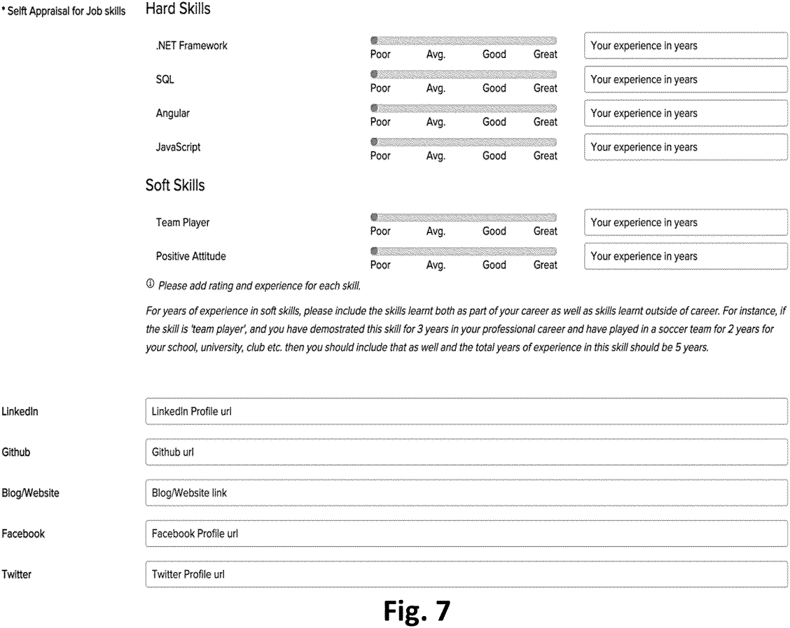

Referring to FIG. 7 which shows another screen of the interface through which self-assessment from the candidates can be obtained. The screen can be presented to the candidates for receiving information, such as the rating of their soft and hard skills, experiences, social profiles, and the like.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system to aid in a recruitment process, the system comprising a processor and a memory, the system configured to implement a method comprising the steps of:
receiving a set of applications for one or more job vacancies;
subjecting the set of applications to a machine learning based multi-layered analysis module, wherein the analysis module upon execution by the processor applies a plurality of filters to the set of applications and further subject the set of applications to profile matching, wherein the analysis module is explainable;
scoring, by the analysis module, each application of the set of applications;
presenting, by the analysis module, a predetermined number of applications from the set of applications based on the scoring;
receive a logical assessment for each of the predetermined number of applications;
updating, the analysis module using reinforcement learning and the logical assessment of the each of the predetermined number of applications; and
upon updating, determining a list of shortlisted applications from the set of applications by subjecting the set of applications to the updated analysis module.

2. The system according to claim 1, wherein the plurality of filters comprises six layers of filtering.

3. The system according to claim 1, wherein the updated analysis module causes rescoring of the each of the set of applications.

4. The system according to claim 1, wherein the method further comprises the steps of: receiving a self-assessment form from a plurality of candidates of the set of applications.

5. The system according to claim 4, wherein the method further comprises the steps of:
receiving a benchmark application, wherein the benchmark application and the self-assessment form are used for the profile matching.

6. The system according to claim 1, wherein the predetermined number of applications are presented such that certain predefined information in the predetermined number of applications is masked to prevent human bias in the logical assessment.

7. The system according to claim 1, wherein the method further comprises the steps of:
providing an interface to receive a weightage for a plurality of hard and soft skill requirements for the one or more job vacancies.

8. A method to aid in a recruitment process, the method implemented within a system comprising a processor and a memory, the method comprising the steps of:
receiving a set of applications for one or more job vacancies;
subjecting the set of applications to a machine learning based multi-layered analysis module, wherein the analysis module upon execution by the processor applies a plurality of filters to the set of applications and further subject the set of applications to profile matching, wherein the analysis module is explainable;
scoring, by the analysis module, each application of the set of applications;
presenting, by the analysis module, a predetermined number of applications from the set of applications based on the scoring;
receive a logical assessment for each of the predetermined number of applications;
updating, the analysis module using reinforcement learning and the logical assessment of the each of the predetermined number of applications; and
upon updating, determining a list of shortlisted applications from the set of applications by subjecting the set of applications to the updated analysis module.

9. The method according to claim 8, wherein the plurality of filters comprises six layers of filtering.

10. The method according to claim 8, wherein the updated analysis module causes rescoring the each of the set of applications.

11. The method according to claim 8, wherein the method further comprises the steps of:
receiving a self-assessment from a plurality of candidates of the set of applications.

12. The method according to claim 11, wherein the method further comprises the steps of:
receiving a benchmark application, wherein the benchmark application and the self-assessment are used for the profile matching.

13. The method according to claim 8, wherein the predetermined number of applications are presented such that certain predefined information in the predetermined number of applications is masked to prevent human bias in the logical assessment.

14. The method according to claim 8, wherein the method further comprises the steps of:
providing an interface to receive a weightage for a plurality of hard and soft skill requirements for the one or more job vacancies.
